(19) United States
(12) Patent Application Publication
(10) Pub. No.: US 2016/0170014 A1
(43) Pub. Date: Jun. 16, 2016

(54) APPARATUS AND METHOD FOR WIRELESS IDENTIFICATION

(71) Applicant: Electronics and Telecommunications Research Institute, Daejeon (KR)

(72) Inventors: Juderk PARK, Daejeon (KR); Yong Sun KIM, Daejeon (KR); Wun-Cheol JEONG, Daejeon (KR); Tae Joon PARK, Daejeon (KR); Hoyong KANG, Daejeon (KR); CHEOL SIG PYO, Daejeon (KR)

(21) Appl. No.: 14/533,939

(22) Filed: Nov. 5, 2014

(30) Foreign Application Priority Data
Nov. 11, 2013 (KR) 10-2013-0135997
Aug. 7, 2014 (KR) 10-2014-0101927

(51) Int. Cl. G01S 13/42; G01S 13/86; G01S 7/04

(52) U.S. Cl. CPC G01S 13/42; G01S 7/04; G01S 13/86

(57) ABSTRACT

An apparatus for wireless identification receives position information on recognition objects searched by a radar from the radar and identifies recognition objects within a communication area of antennas using signals responding to wireless frequency signals which are transmitted while changing beam directions of the antennas, for the recognition objects searched by the radar.

### CROSS-REFERENCE TO RELATED APPLICATION

This application claims priority to and the benefit of Korean Patent Application No. 10-2013-0135997 and 10-2014-0101927 filed in the Korean Intellectual Property Office on Nov. 11, 2013 and Aug. 7, 2014, the entire contents of which are incorporated herein by reference.

### BACKGROUND OF THE INVENTION

(a) Field of the Invention

The present invention relates to a method and an apparatus for wireless identification, and more particularly, to a method and an apparatus for wireless identification that is capable of identifying objects positioned at a long distance.

(b) Description of the Related Art

To acquire recognition information on things which are distributed over an extensive area like ships distributed on the sea, a method for identifying them using a long-range wireless frequency is required.

Generally, a passive radio frequency identification (RFID) system which is used to recognize things has a recognition range of approximately 10 m, and an active RFID system has a recognition range of about 300 m.

To recognize things distributed over an extensive area, a radar system has been used. To recognize ships distributed on the sea, the radar system transmits an impulse signal and receives signals reflected back from ships to determine positions, sizes, and the like of the ships based on a post-processing process. However, the radar system may not acquire permissions of ships, information on ships, or the like.

To provide long-range recognition using a wireless frequency, a method for increasing an output of a communication system has been used; however, the output of the communication system is restricted by regulations or technological standards.

Further, a directional antenna has been used to increase effective radio wave strength with a restricted output in a wireless recognition system. In this case, to control a direction of a radio wave beam radiated or received from the directional antenna, a process of analyzing a phase from a received signal to detect the direction is required. In this case, in order to control the direction, the received signal needs to represent an omnidirectional characteristic. Therefore, in the wireless system communicating in any direction, a direction control antenna needs to have both an omnidirectional radiation characteristic and directional radiation characteristic and detect a receiving direction of the radio wave while switching the radiation direction during detection of a signal and transmission/reception of data, and therefore requires a very complex structure of an antenna, an antenna control apparatus, a processing apparatus, and the like, as well as high performance. Further, when the wireless recognition system is equipped in a mobile object, very fast processing speed and controllability are required.

An identification system requiring a long recognition range due to extensively distributed recognition objects like ships which are concentrated on the sea may use a method for securing a communication distance using radiation beam steering of the antenna. In this case, the identification system needs to quickly acquire information on directions in which the recognition objects are present.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for wireless identification capable of quickly determining a direction of a recognition object and intensively performing identification on an area of the direction.

An exemplary embodiment of the present invention provides a method for wireless identification of an apparatus for wireless identification for identifying recognition objects. The method for wireless identification may include: receiving position information on recognition objects searched by a radar from the radar; displaying the recognition objects searched by the radar within a monitoring area based on the position information; and identifying recognition objects within a communication area of antennas using signals responding to wireless frequency signals which are transmitted while changing beam directions of the antennas, for the recognition objects searched by the radar.

The method for wireless identification may further include: when the identifying of the recognition objects within the communication area of the antennas is complete, moving a position; and identifying the recognition objects within the communication area of the antennas while controlling the beam directions of the antennas, for the recognition objects searched by the radar.

The identifying of the recognition objects within the communication area of the antennas may include: dividing the communication area of the antennas into a plurality of areas; transmitting radio wave beams including request signals to each of the areas by sequentially steering antennas based on each of the plurality of areas; receiving response signals from the recognition objects of each area receiving the request signals; and identifying the recognition objects of each area from the response signals.

The identifying of the recognition objects of each area from the response signal may include: extracting GPS coordinate information and unique identification from the response signals; and assigning the unique identification to the recognition objects of the same position by comparing the position information on the recognition objects searched by the radar with the GPS coordinate information.

The identifying of the recognition objects within the communication area of the antennas may further include: dividing the recognition objects searched by the radar into an identified state and a non-identified state depending on whether the recognition objects searched by the radar are identified in each area.

The response signal may include the unique identification of the recognition object, and detail information and the GPS coordinate information on the recognition object.

Another exemplary embodiment of the present invention provides an apparatus for wireless identification for identifying recognition objects. The apparatus for wireless identification may include a direction control antenna, an antenna controller, a querier, and a processor. The direction control antenna may transmit radio wave beams depending on beam directions. The antenna controller may rotate the beam direction of the direction control antenna 360° at a predetermined interval. The querier may transmit request signals in each beam direction through the direction control antenna, and receive response signals responding to the request signals through the direction control antenna. The processor may receive position information on the recognition objects searched by the radar, and identify the recognition objects within the communication area of the antenna using the response signals for the recognition objects searched by the radar.

The apparatus for wireless identification may be installed in a mobile object, and when the identification of recognition objects within the communication area of the antennas is complete, the apparatus for wireless identification may move to another position to identify the recognition objects searched by the radar.

The processor may extract GPS coordinate information from the response signals received in each beam direction, and assign identification extracted from the response signals to the recognition objects of the same position by comparing the position information on the recognition objects searched by the radar with the GPS coordinate information.

The processor may divide the recognition objects searched by the radar into an identified state and a non-identified state depending on whether the recognition objects are identified using the response signals received in each beam direction.

The apparatus for wireless identification may further include a monitoring and tracking manager configured to track and manage the recognition objects which are not identified from the response signals among the recognition objects searched by the radar using the radar.

The response signal may include the unique identification of the recognition object, and detail information and the GPS coordinate information on the recognition object.

### BRIEF DESCRIPTION OF THE DRAWINGS

FIG. 1 is a diagram illustrating an apparatus for wireless identification according to an exemplary embodiment of the present invention.

FIG. 2 is a diagram illustrating a distribution of a recognition object acquired from a radar illustrated in FIG. 1.

FIG. 3 is a flowchart illustrating a method for recognition object identification according to an exemplary embodiment of the present invention.

FIGS. 4 to 6 are each diagrams illustrating a method for recognition object identification according to an exemplary embodiment of the present invention.

FIG. 7 is a diagram illustrating an example in which the apparatus for wireless identification according to the exemplary embodiment of the present invention is applied to fishing boats which are operated on the sea to identify operation permissions.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

Hereinafter, an apparatus and a method for wireless identification according to an exemplary embodiment of the present invention will be described with reference to the accompanying drawings.

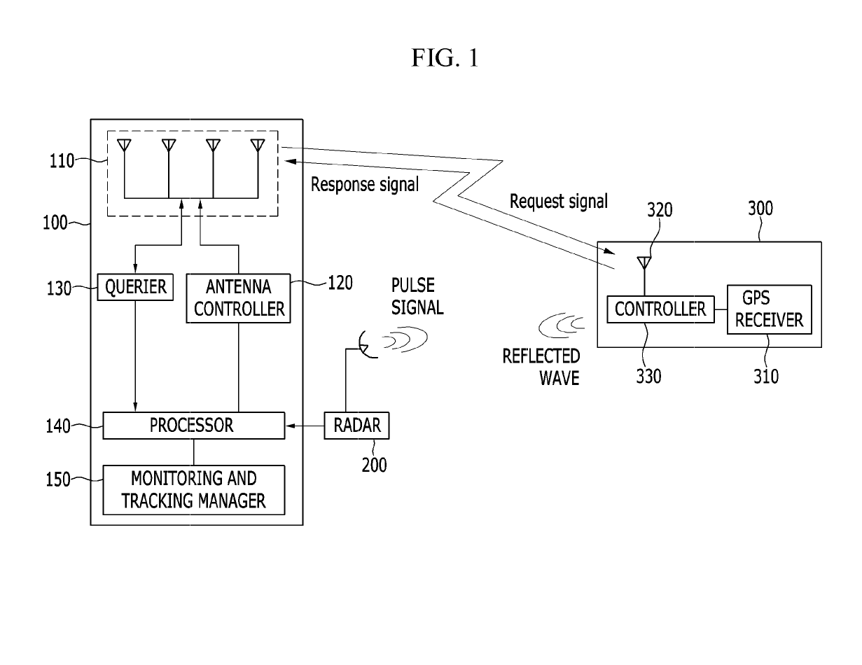

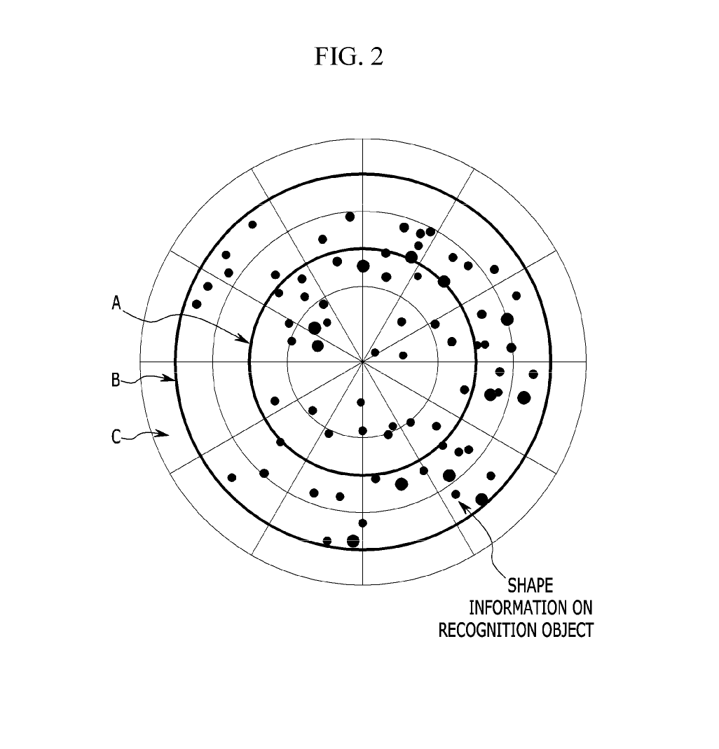

FIG. 1 is a diagram illustrating an apparatus for wireless identification according to an exemplary embodiment of the present invention, and FIG. 2 is a diagram illustrating a distribution of a recognition object acquired from a radar illustrated in FIG. 1.

Referring to FIG. 1, an apparatus 100 for wireless identification identifies recognition objects by interlocking with a radar 200, and includes a direction control antenna 110, an antenna controller 120, a querier 130, a processor 140, and a monitoring and tracking manager 150. The apparatus 100 for wireless identification may be equipped in a mobile object.

The radar 200 transmits an omnidirectional pulse signal. The transmitted pulse signal is reflected by the recognition object and the radar 200 processes a signal reflected from the recognition object to acquire position information on the recognition object. The radar 200 transmits the acquired position information of the recognition object to the processor 140 of the apparatus 100 for wireless identification. The radar 200 has a recognition range of hundreds of kilometers.

In the apparatus 100 for wireless identification, the direction control antenna 110 is an antenna which may provide beam direction control, and steers a radio wave beam in the corresponding direction depending on the beam direction control of the antenna controller 120. The direction control antenna 110 transmits the radio wave beam with restricted output.

In particular, the direction control antenna 110 transmits the radio wave beam while rotating 360° in a predetermined interval depending on the beam direction control.

The antenna controller 120 controls the beam direction of the direction control antenna 110 according to a wireless identification procedure. The antenna controller 120 rotates the beam direction 360° in a predetermined interval so as to identify all recognition objects within a communication area of the direction control antenna 110.

The querier 130 transmits a request signal querying detail information and GPS coordinate data of the recognition object through the direction control antenna 110, receives a response signal in response to the request signal through the direction control antenna 110, and transmits the received response signal to the processor 140.

The processor 140 acquires the position information on the recognition object from the radar 200, differentiates the recognition objects searched by the radar 200 depending on the position information, and displays the differentiated recognition objects within the monitoring area. For example, the monitoring area may be divided into a communication area A of the direction control antenna 110, an area B which may be searched by the radar 200, and an external area C which is not searched by the radar 200. In this case, the processor 140 may divide and display the recognition objects searched by the radar 200 into the communication area of the direction control antenna 110, the area which may be searched by the radar 200, and the external area which is not searched by the radar 200.

The processor 140 identifies the recognition object using the response signal received through the direction control antenna 110, for the recognition object recognized by the radar 200. In particular, the processor 140 may identify the detail information on the recognition object using the response signal.

The monitoring and tracking manager 150 manages the recognition objects searched by the radar 200 and the recognition object identified by the apparatus 100 for wireless identification within the monitoring area. The monitoring and tracking manager 150 may track and manage the recognition object which is not identified by the apparatus 100 for wireless identification among the recognition objects searched by the radar 200 using the radar 200.

A tag apparatus 300 includes a GPS receiver 310, an antenna 320, and a controller 330. The tag apparatus 300 is equipped in the recognition object.

In the tag apparatus 300, the GPS receiver 310 uses a satellite signal to calculate GPS coordinates corresponding to the position of the recognition object in which the tag apparatus 300 is equipped, and transmits the GPS coordinate information to the controller 330.

The antenna 320 receives the request signal transmitted from the apparatus 100 for wireless identification and transmits the received request signal to the controller 330. Further, the antenna 320 transmits the response signal transmitted from the controller 330. The antenna 320 may be an omnidirectional antenna.

The controller 330 stores the detail information associated with the recognition object including unique identification (ID) of the recognition object, and responds to the request signal to transmit the response signal including the detail information and the GPS coordinate information on the recognition object through the antenna 320. When the recognition object is a ship, the detail information may include, for example, operation permissions of the ship, information on the ship, or the like.

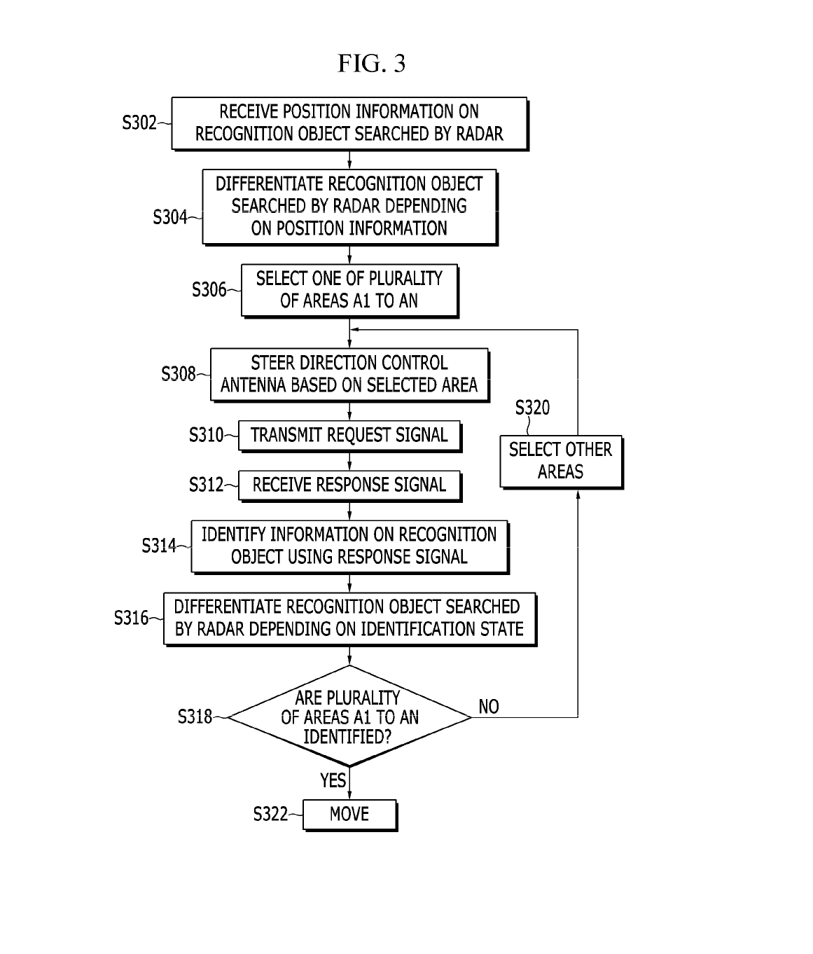

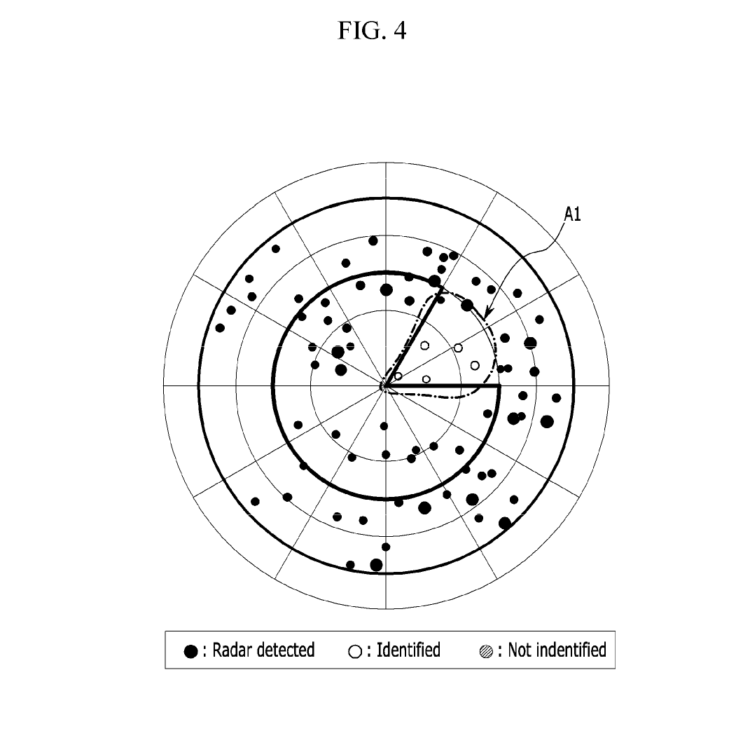

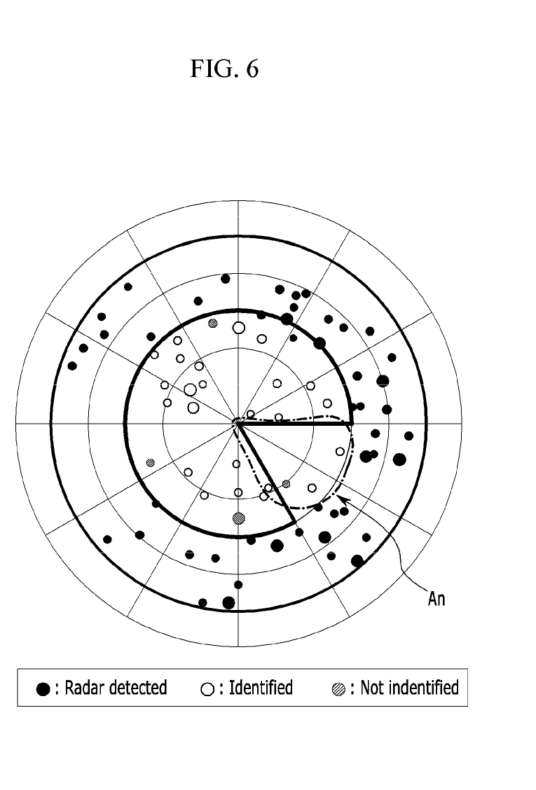

FIG. 3 is a flowchart illustrating a method for recognition object identification according to an exemplary embodiment of the present invention, and FIGS. 4 and 6 are each diagrams illustrating a method for recognition object identification according to an exemplary embodiment of the present invention.

Referring to FIG. 3, the apparatus 100 for wireless identification receives the position information on the recognition objects searched by the radar 200 (S302).

The apparatus 100 for wireless identification differentiates and displays the recognition objects searched by the radar 200 within the monitoring area depending on the position information (S304).

The apparatus 100 for wireless identification starts to identify the recognition objects searched by the radar 200.

The apparatus 100 for wireless identification divides the communication area A of the direction control antenna 110 into a plurality of areas A1 to An, and selects one (for example, A1) of the plurality of areas (S306).

The apparatus 100 for wireless identification steers the direction control antenna 110 based on the selected area A1 to transmit the radio wave beam including the request signal to the area A (S308 to S310).

The apparatus 100 for wireless identification receives the response signal from the recognition object of the area A1 in which the request signal is received (S312), and analyzes the response signal to identify the information on the recognition object (S314). The apparatus 100 for wireless identification extracts the unique ID and the GPS coordinate information from the response signal. The apparatus 100 for wireless identification compares the extracted GPS coordinate information with the position information acquired from the radar 200 to confirm the same recognition objects based on approximation, and if it is confirmed that the recognition objects are the same, assigns the unique ID and the detail information to the corresponding recognition object to identify the recognition object.

The apparatus 100 for wireless identification differentiates the recognition objects searched by the radar 200 within the area A1 depending on a state in which the recognition objects are identified by the apparatus 100 for wireless identification. As illustrated in FIG. 4, the apparatus 100 for wireless identification may divide the recognition objects searched by the radar 200 within the area A1 into the state in which the recognition objects are identified or the state in which the recognition objects are not identified by the apparatus 100 for wireless identification.

When completing the identification of the area A1, the apparatus 100 for wireless identification confirms whether all the recognition objects within the plurality of areas A1 to An are identified (S318).

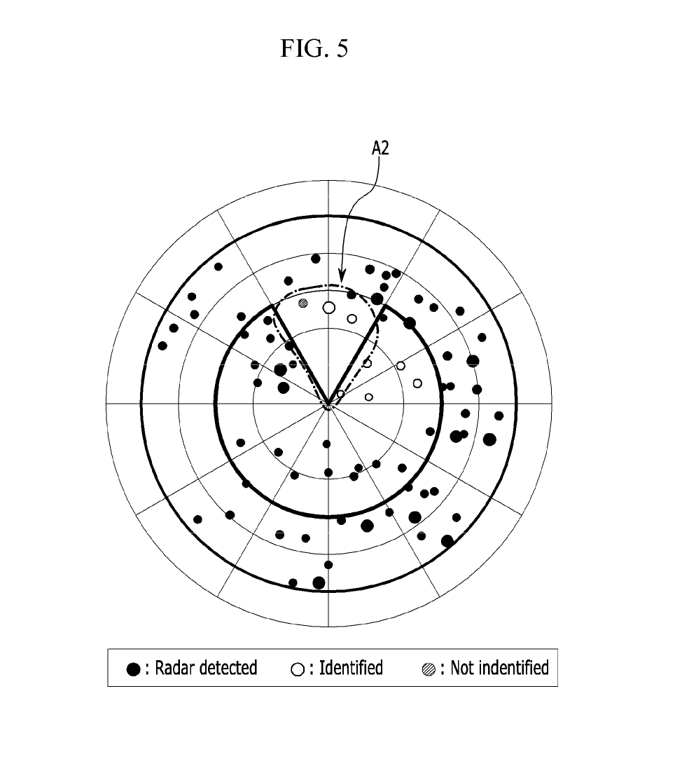

When not identifying all the recognition objects within the plurality of areas A1 to An, the apparatus 100 for wireless identification selects another (for example, A2) of the plurality of areas A1 to An (S320), steers the direction control antenna 110 based on the selected area A2 (S308), and performs steps S310 to S316. As the result, as illustrated in FIG. 5, the apparatus 100 for wireless identification may differentiate the recognition objects searched by the radar 200 depending on the identification state of the apparatus 100 for wireless identification. Here, steering the antenna 110 means steering a radio wave transmitted/received direction to/from the antenna 110, and as a method for steering the antenna 110, a method for mechanically controlling the antenna 110 and a method for electronically controlling the antenna 110 may be used.

The apparatus 100 for wireless identification repeats steps S318, S320, and S308 to S316 until all the recognition objects within the plurality of areas A1 to An are identified.

When the recognition objects within the plurality of areas A1 to An are identified by the above methods, as illustrated in FIG. 6, all the recognition objects within the communication area of the direction control antenna 110 are differentiated depending on the identification state.

In this case, the recognition objects which are not identified by the apparatus 100 for wireless identification may be separately tracked and managed by the radar 200.

When the mobile objects in the range of the apparatus 100 for wireless identification are identified within the communication area of the direction control antenna 110 based on the above methods, the apparatus 100 is moved for identification of the area where the identification has not been performed among recognition objects searched only by the radar 200.

Further, the identification steps S304 to S320 are repeated at the position moved to.

As such, the apparatus 100 for wireless identification according to the exemplary embodiment of the present invention uses the direction detected by the radar 200 to detect the receiving direction of the radio wave and therefore may omit a process of receiving the radio wave using the omnidirectional antenna to detect the receiving direction of the radio wave as in the related art. Therefore, many complex processing processes may be omitted and rapid direction determination and control may be made.

Further, the recognition objects which are distributed over a wide area may be identified and the detail information on the recognition object as well as the position information on the recognition object may be identified.

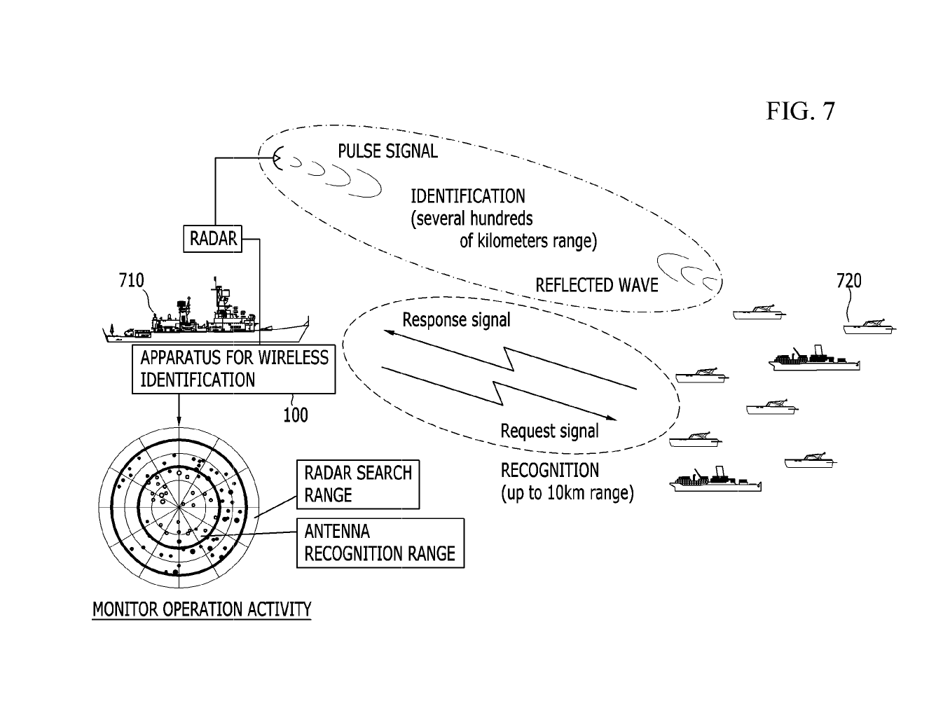

FIG. 7 is a diagram illustrating an example in which the apparatus for wireless identification according to the exemplary embodiment of the present invention is applied to fishing boats which are operated on the sea to identify operation permissions.

Referring to FIG. 7, the environment in which fishing boats on the sea are managed includes a patrol boat 710 and a plurality of ships 720.

The patrol boat 710 is a ship for finding and managing information on the plurality of ships. The apparatus 100 for wireless identification according to the exemplary embodiment of the present invention may be equipped in the patrol boat 710.

The plurality of ships 720 are ships which are managed by the patrol boat 710 as the recognition objects. The tag apparatus 300 according to the exemplary embodiment of the present invention may be equipped in the plurality of ships 720, respectively. The tag apparatus 300 responds to the pulse signal of the radar to generate the reflected wave and responds to the request signal transmitted from the apparatus 100 for wireless identification to transmit the response signal including the unique ID and the GPS coordinate information.

The range searched by the radar 200 may be several hundreds of kilometers, and the radar 200 may search the position information on remote ships.

The apparatus 100 for wireless identification equipped in the patrol boat 710 identifies the ships 720 within the communication area of the direction control antenna 110 using the direction control antenna 110 for identification of the ships searched by the radar 200, the apparatus 100 is moved to identify the ships 720 within the area searched by the radar 200.

The apparatus 100 for wireless identification may divide and manage all the ships within the monitoring area into the state in which the ships are identified or the state in which the ships are not identified by the apparatus 100 for wireless identification, or the state in which the ships are searched by the radar 200.

In particular, the patrol boat 710 may use the apparatus 100 for wireless identification to confirm the information (for example, a kind of ship, operation permissions, and the like) on the ship 720 from the response signal of the tag apparatus 300 which is equipped in the ship 720.

When the identification process of the apparatus 100 for wireless identification is complete, the patrol boat 710 may separately track and manage the fishing boats which are searched by the radar 200 but are not identified by the apparatus 100 for wireless identification by using the radar 200.

In this way, the patrol boat 710 may use the apparatus 100 for wireless identification to monitor the operation situations of the ships 720.

According to an exemplary embodiment of the present invention, it is possible to construct the long-range identifiable system using the restricted output of the radio wave when the apparatus for wireless identification is applied to areas such as a sea, a wide plain, or a coastline, which may be easily searched by the radar. The apparatus for wireless identification may interlock with the long-range search and tracking management function of the radar to preemptively prevent the illegal operation of fishing boats which are operated at the area of EEZ and be applied to the offshore fisheries status management around the coastline. Further, it is possible to construct a long-range identification friend or foe system by applying the apparatus for wireless identification to situations in which a plurality of warships or armored ships are concentrated and thus perform a military action or a battle.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for wireless identification of an apparatus for wireless identification for identifying recognition objects, the method comprising:
receiving position information on recognition objects searched by a radar from the radar;
displaying the recognition objects searched by the radar within a monitoring area based on the position information; and
identifying recognition objects within a communication area of antennas using signals responding to wireless frequency signals which are transmitted while changing beam directions of the antennas, for the recognition objects searched by the radar.

2. The method of claim 1, further comprising:
when the identifying of the recognition objects within the communication area of the antennas is complete, moving a position; and
identifying the recognition objects within the communication area of the antennas while controlling the beam directions of the antennas, for the recognition objects searched by the radar.

3. The method of claim 1, wherein
the identifying of the recognition objects within the communication area of the antennas includes:
dividing the communication area of the antennas into a plurality of areas;
transmitting radio wave beams including request signals to each of the areas by sequentially steering the antennas based on each of the plurality of areas;
receiving response signals from the recognition objects of each area receiving the request signals; and
identifying recognition objects of each area from the response signals.

4. The method of claim 3, wherein
the identifying of the recognition objects of each area from the response signals includes:
extracting GPS coordinate information and unique identification from the response signals; and
assigning the unique identification to recognition objects of the same position by comparing the position information on the recognition objects searched by the radar with the GPS coordinate information.

5. The method of claim 3, wherein
the identifying of the recognition objects within the communication area of the antennas further includes dividing the recognition objects searched by the radar into an identified state and a non-identified state depending on whether the recognition objects searched by the radar are identified in each area.

6. The method of claim 3, wherein
the response signal includes unique identification of the recognition object, and detail information and GPS coordinate information on the recognition object.

7. The method of claim 1, wherein
the recognition object is a ship located on the sea, and
the apparatus for wireless identification is installed in a patrol boat managing the ship.

8. An apparatus for wireless identification for identifying recognition objects, comprising:
a direction control antenna configured to transmit radio wave beams depending on beam directions;
an antenna controller configured to rotate the beam direction of the direction control antenna 360° at a predetermined interval;
a querier configured to transmit request signals in each beam direction through the direction control antenna and receive response signals responding to the request signals through the direction control antenna; and
a processor configured to receive position information on recognition objects searched by a radar and identify recognition objects within a communication area of the antenna using the response signals for the recognition objects searched by the radar.

9. The apparatus of claim 8, wherein
the apparatus for wireless identification is installed in a mobile object, and when the identification of the recognition objects within the communication area of the antennas is complete, the apparatus for wireless identification moves to another position to identify the recognition objects searched by the radar.

10. The apparatus of claim 8, wherein
the processor extracts GPS coordinate information from the response signals received in each beam direction, and assigns identification extracted from the response signals to recognition objects of the same position by comparing the position information on the recognition objects searched by the radar with the GPS coordinate information.

11. The apparatus of claim 8, wherein
the processor divides the recognition objects searched by the radar into an identified state and a non-identified state depending on whether the recognition objects are identified using the response signals received in each beam direction.

12. The apparatus of claim 11, further comprising
a monitoring and tracking manager configured to track and manage the recognition objects which are not identified from the response signals among the recognition objects searched by the radar using the radar.

13. The apparatus of claim 8, wherein
the response signal includes unique identification of the recognition object, and detail information and GPS coordinate information on the recognition object.

14. The apparatus of claim 8, wherein
the recognition object is a ship located on the sea, and
the apparatus for wireless identification is installed in a patrol boat managing the ship.
